(19) United States
(12) Patent Application Publication
(10) Pub. No.: US 2014/0198648 A1
(43) Pub. Date: Jul. 17, 2014

(54) IDENTIFICATION OF DATA FLOWS BASED ON ACTIONS OF QUALITY OF SERVICE POLICIES

(71) Applicant: CISCO TECHNOLOGY, INC., San Jose, CA (US)

(72) Inventors: Vijaya Kumar KULKARNI, Bangalore (IN); Suraj BAPU, Bangalore (IN); Tarun SAXENA, Bangalore (IN); Anu CHAUHAN, Ithaca, NY (US)

(73) Assignee: CISCO TECHNOLOGY, INC., San Jose, CA (US)

(21) Appl. No.: 13/741,671

(22) Filed: Jan. 15, 2013

(51) Int. Cl. H04L 12/56

(52) U.S. Cl. CPC H04L 47/2441
USPC 370/235

(57) ABSTRACT

In one embodiment, a method comprises determining a Quality of Service (QoS) policier action for data packets belonging to a first flow of data packets received at an ingress interface of a network switching device, the QoS policier action based on one of multiple prescribed QoS classifications by a QoS policier that aggregates distinct flows of data packets into a single aggregated flow according to prescribed QoS thresholds; and assigning to the first flow of data packets a unique identifier that associates the QoS policier action to identification of the first flow of data packets, enabling identification of the distinct flows of data packets within each of the prescribed QoS classifications.

### TECHNICAL FIELD

The present disclosure generally relates to aggregate policing of data flows and network switching devices, for example Ethernet network switching devices—or Internet Protocol (IP) routers. More particularly, the present disclosure relates to aggregate policing by a network switching device of data traffic based on quality of service (QoS) classification.

### BACKGROUND

This section describes approaches that could be employed, but are not necessarily approaches that have been previously conceived or employed. Hence, unless explicitly specified otherwise, any approaches described in this section are not prior art to the claims in this application, and any approaches described in this section are not admitted to be prior art by inclusion in this section.

NetFlow is a network protocol for collecting Internet protocol (IP) traffic information, described in the Internet Engineering Task Force (IETF) Request for Comments (RFC) 3954. NetFlow is enabled on a per-interface basis within a network device, for example a network router or network switch. NetFlow generates flow records based on detecting IP flows on a given network interface: IP flows can be defined as a unidirectional sequence of packets that all share prescribed values, for example ingress interface, source address, destination IP address, IP protocol, source port for UDP/TCP, destination port for UDP/TCP, and/or IP type of service (TOS).

Aggregate policing can be implemented in a network device, where the aggregate bandwidth among data sources supplying data packets to an ingress interface of the network device is limited to a prescribed limit based on, for example, the capacity of the destination. Data packets received on an ingress interface can be identified for aggregate policing based on IP access lists, IP precedence settings, QoS groups, source Media Access Control (MAC) addresses, etc. The prescribed limit can be set based on average data rate (e.g., “committed access rate” (CAR)), or a burst/peak size (e.g., “peak information rate” (PIR)). Policing can be implemented on an interface by changing the QoS attributes of a packet in a traffic flow (i.e., marking), or dropping packets that violate the prescribed limit. Hence, assuming an aggregate policing (e.g., a QoS policy class) limits data to two megabits per second (2 Mb/s), a first data source to the ingress interface providing a disproportional amount of data traffic (e.g., 1.5 Mb/s) can adversely affect second and third data sources each providing a proportional amount of data traffic (e.g., 0.65 Mb/s), causing the network device to drop a disproportionate number of data packets from the second and third data sources due to the data traffic from the first data source. Moreover, there currently is no operation for identifying different data traffic flows within a QoS policy class that may be causing dropping of data packets due to the aggregating policing. Aggregate policing is separate and distinct from any Netflow implementation.

### BRIEF DESCRIPTION OF THE DRAWINGS

Reference is made to the attached drawings, wherein elements having the same reference numeral designations represent like elements throughout and wherein:

FIG. 1 illustrates an example apparatus (i.e., machine) configured for executing a quality of service-based identification of data flows that associates a quality of service (QoS) policier action to identification of each data flow within an aggregated data flow, according to an example embodiment.

FIG. 2 illustrates an example method of identifying each data flow, within an aggregated data flow, with one or more unique identifiers that associate the corresponding data flow with one or more respective QoS policier actions, according to an example embodiment.

FIG. 3 illustrates example data structures enabling identification of the relative proportions for each of the distinct data flows within each of the prescribed QoS classifications, according to an example embodiment.

### DESCRIPTION OF EXAMPLE EMBODIMENTS

### Overview

In one embodiment, a method comprises determining a Quality of Service (QoS) policier action for data packets belonging to a first flow of data packets received at an ingress interface of a network switching device, the QoS policier action based on one of multiple prescribed QoS classifications by a QoS policier that aggregates distinct flows of data packets into a single aggregated flow according to prescribed QoS thresholds; and assigning to the first flow of data packets a unique identifier that associates the QoS policier action to identification of the first flow of data packets, enabling identification of the distinct flows of data packets within each of the prescribed QoS classifications.

In another embodiment, an apparatus comprises a plurality of ingress interfaces, each ingress interface configured for receiving one or more flows of data packets; and a circuit configured for aggregating distinct flows of data packets into a single aggregated data flow according to prescribed Quality of Service (QoS) thresholds, the circuit further configured for determining a QoS policier action for at least data packets belonging to a first of the flows of data packets, based on one of multiple prescribed QoS classifications applied to the single aggregated data flow, and assigning to the first flow of data packets a unique identifier that associates the QoS policier action to identification of the first flow of data packets, enabling identification of the distinct flows of data packets within each of the prescribed QoS classifications.

In another embodiment, logic is encoded in one or more non-transitory tangible media for execution by a machine and when executed operable for: determining a Quality of Service (QoS) policier action for data packets belonging to a first flow of data packets received at an ingress interface of a network switching device, the QoS policier action based on one of multiple prescribed QoS classifications by a QoS policier that aggregates distinct flows of data packets into a single aggregated flow according to prescribed QoS thresholds; and assigning to the first flow of data packets a unique identifier that associates the QoS policier action to identification of the first flow of data packets, enabling identification of the distinct flows of data packets within each of the prescribed QoS classifications.

### DETAILED DESCRIPTION

Particular embodiments integrate flow identification with actions performed by a Quality of Service (QoS) policier configured for integrating multiple data flows into a single aggregated flow according to prescribed QoS thresholds. A “policier” refers to logic configured for implementing QoS policing actions such as drop, permit or remark for a data packet that has just arrived (also referred to as a “newly-arrived data packet” or “newly-received data packet”). The policing actions for the newly-arrived data packet are based on the earlier arrival pattern of earlier-received data packets belonging to the same QoS classification group as the newly-arrived data packet; example earlier arrival patterns can include average arrival rate or instantaneous burst of the earlier-received data packets belonging to the same QoS classification group as the newly-received data packet.

The QoS policier classifies each data packet in one of multiple QoS classes based on the respective prescribed thresholds, and the QoS policier circuit assigns to the data packet a QoS policier action corresponding to the QoS class; hence, the QoS classes and their respective QoS actions establish the QoS policy that is applied to ingress interfaces receiving one or more flows of data packets. A unique identifier can be established that associates the QoS policier action applied to one or more data packets of a given data flow with identification of the given data flow. Hence, the data packets of distinct data flows that are operating within different QoS classes can be identified based on their classification within each of the QoS classes, enabling identification of the relative proportions of each of the distinct data flows within each of the QoS classes. Example QoS classes can include data flows that conform with QoS policies (e.g., maintain data rates below a prescribed committed access rate (CAR)), data flows that temporarily exceed QoS policies (e.g., a data burst exceeds the CAR but remains below a prescribed peak information rate (PIR)), or data flows that violate QoS policies (e.g., data rates exceed both CAR and PIR). Moreover, the QoS policier can establish multiple identifiers for each data flow based on respective QoS policier actions, enabling identification of the different QoS classifications encountered by a data flow as bandwidth utilization dynamically changes over time.

Hence, the particular embodiments enable dynamic identification of data flows that are dynamically classified by the QoS policier into different QoS classifications in response to changes in bandwidth utilization rates by the identified data flows. Hence, data flows can be precisely identified with respect to their relative compliance (or violations) of QoS policies, including identifying the relative proportions of each of the data flows within the prescribed QoS classifications.

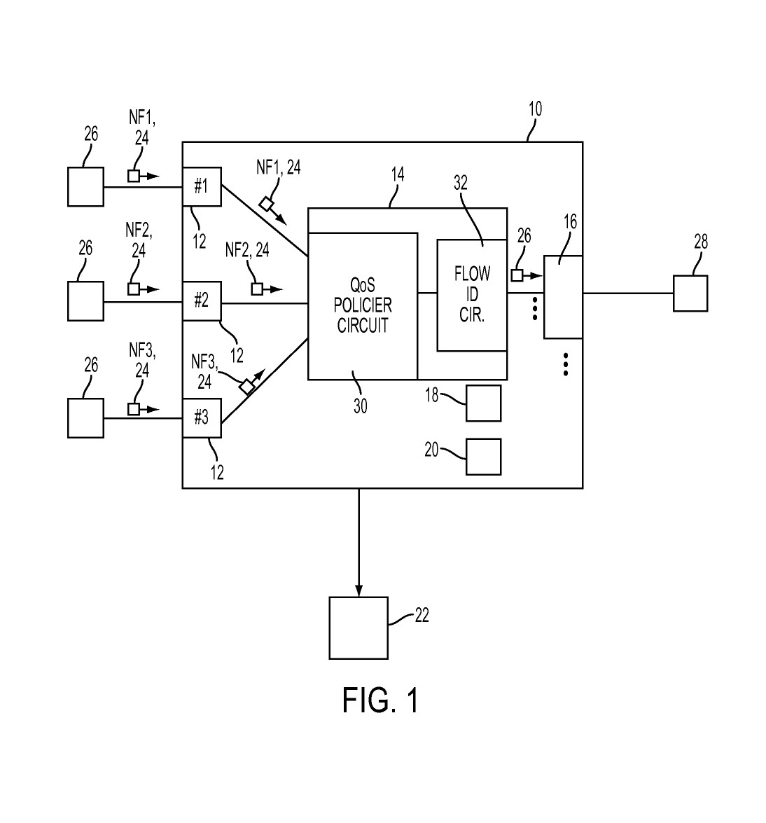

FIG. 1 illustrates an example apparatus 10 configured for executing a quality of service-based identification of data flows, according to an example embodiment. The apparatus 10 is a physical machine (i.e., a hardware device), implemented for example as a network switching device or an Internet Protocol (IP) router. The apparatus 10 can include a plurality of ingress interface circuits 12, a circuit 14 for associating QoS policier actions to identification of data flows as described herein, one or more egress interface circuits 16, a memory circuit 18, and an administrator circuit 20. The apparatus 10 also can optionally include a collector circuit 22 (shown in FIG. 1 optionally as external to the apparatus 10). An example of the apparatus 10 is the commercially available Cisco Nexus 7000 series modular switching system that is modified as described herein.

Each ingress circuit 12 can be configured for receiving one or more flows of data packets 24 from a data source 26, for example a host computer or another network element such as a switching device, network router, gateway, etc. The circuit 14 (e.g., a processor circuit or application specific integrated circuit) can be configured for aggregating distinct flows 24 of data packets from one or more of the ingress circuits 12 into a single aggregated data flow 26 that can be output to the egress circuit 16 for delivery to another network node 28. In one example embodiment, the circuit 14 can be implemented to include a QoS policier circuit 30 and a flow identification circuit 32, described below.

Since the egress circuit 16 and/or the network node 28 may have a limited capacity, the circuit 14 (e.g., the QoS policier circuit 30) is configured for aggregating the distinct flows of data packets into the single aggregated data flow 26 according to prescribed QoS thresholds. In particular, the circuit 14 (e.g., the QoS policier circuit 30) can be configured for establishing multiple QoS thresholds for average data traffic rates and burst traffic, in order to ensure that no incoming data flow 24 overwhelms the egress circuit 16 by creating a congestion condition. The multiple QoS thresholds are used to define QoS classes, where each QoS class has a corresponding QoS policier action, described below. The QoS policy (comprising the QoS classes and their respective QoS policier actions) can be enforced by the circuit 14 on any one or all of the ingress interface circuits 12 based on classifying each received data packet on each ingress interface circuit 12 into one of the QoS classes, and applying the corresponding QoS policier action.

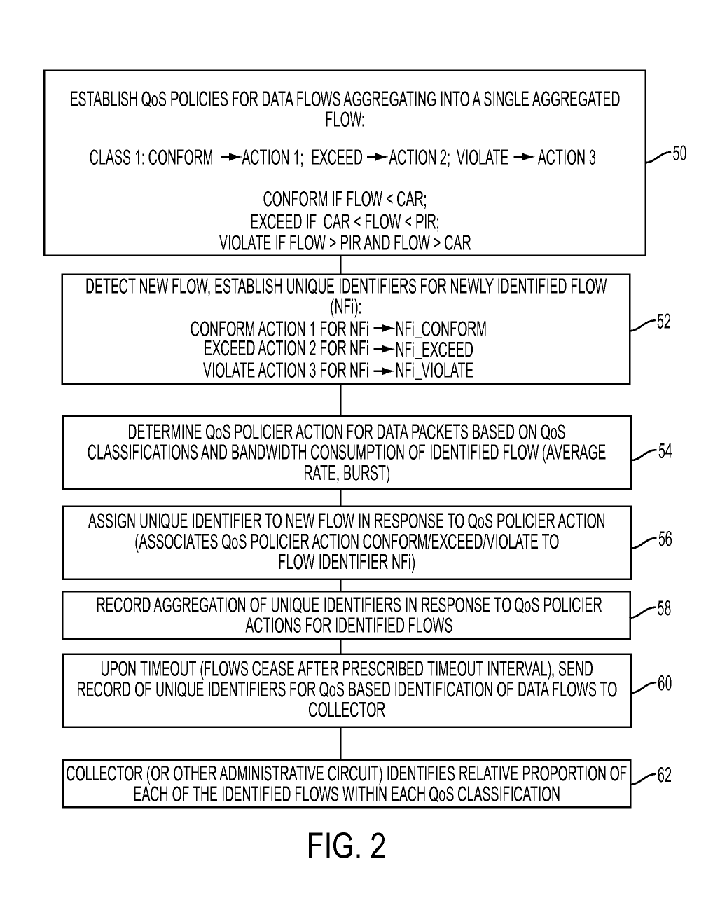

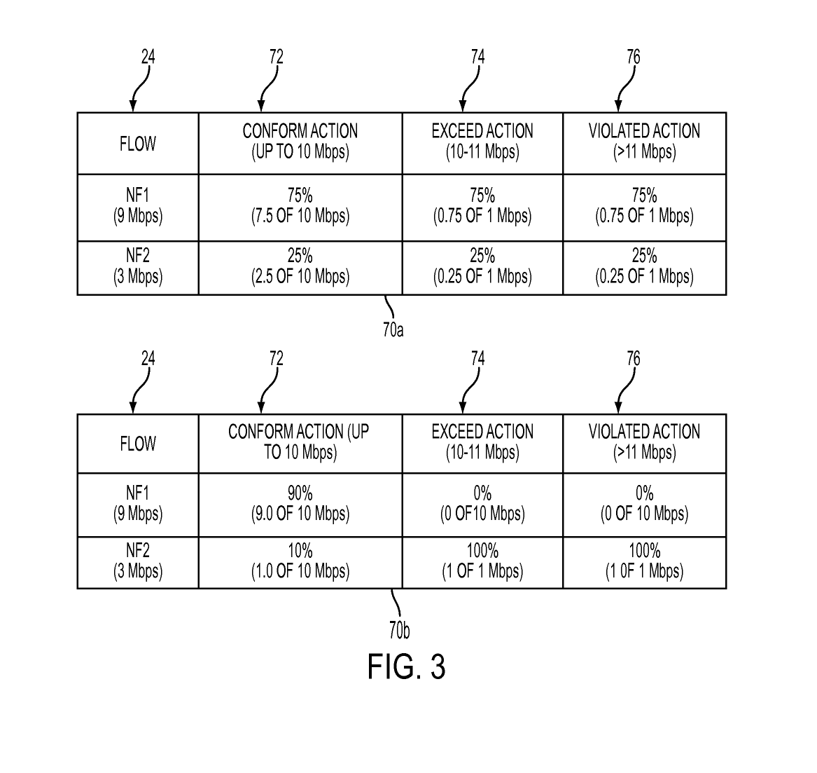

According to an example embodiment, the circuit 14 is configured for associating QoS policier actions to identification of a given data flow, illustrated in FIG. 2 as flow identifiers (“NFi”) for a given data flow (“i”) 24. Hence, data flows can be identified not only with respect to flow-based identification (e.g., ingress interface, source IP address, destination IP address, IP protocol, source UDP/TCP port, destination UDP/TCP port, IP TOS), but also with respect to the QoS action executed on data packets of an identified data flow. As described below with respect to FIG. 3, the quality of service-based identification of data flows enables identification of the distinct flows of data packets within each of the prescribed QoS classifications, enabling identification of data flows that are consuming more than their fair share of bandwidth relative to the data flows within an aggregated flow. Moreover, the identification of data flows with respect to the QoS actions by the circuit 14 enables dynamic identification as data flows change their relative bandwidth utilization over time.

FIG. 2 illustrates an example method by the circuit 14 of assigning a unique identifier that associates a QoS policier action to identification of a flow of data packets that affects aggregation by the circuit 14, according to an example embodiment. The following description will be described with respect to the operations of the QoS policier circuit 30 and the flow identifier circuit 32, although it is apparent that all operations described herein can be implemented within the circuit 14 as a single, integrated device.

Referring to operation 50, the QoS policier circuit 30 can establish QoS policies for each of the data flows 24 that are aggregated by the QoS policier circuit 30 into the single aggregated data flow 26. For example, the QoS policier circuit 30 can determine a prescribed committed access rate (CAR) based on the number of incoming data flows 24 relative to the maximum allowable bandwidth for the single aggregated flow 26 into the egress circuit 16: for example, assuming a maximum allowable bandwidth of 11 megabits per second for the egress interface circuit 16, the QoS policier circuit 14 can set the CAR at 10 megabits per second for the aggregated data flow; the QoS policier circuit 14 also can set the PIR at 11 megabits per second (i.e., up to 1 megabits per second over the CAR), such that data packets above the 10 megabit per second CAR threshold but below the 11 megabit per second PIR threshold are labeled with an “action 2” identifier. Hence, the QoS policier circuit 30 can determine a QoS classification (“Class 1”) for each of the data flows 24 that are to be aggregated into the single aggregated data flow 26, namely that data packets are classified as “action 1” if the data packets are in the conformed class (e.g., if the aggregated data flow 26 is less than the CAR), data packets are classified as “action 2” if the data packets cause the aggregated data flow 26 to reach the exceed class (e.g., the aggregated data flow 26 is greater than the CAR but less than the PIR), and that data packets are classified as “action 3” if the data packets cause the aggregated data flow 26 to reach the violate class (e.g., the aggregated data flow is greater than both the CAR and the PIR). The QoS policier circuit 30 also can be configured for identifying each received data packet with a QoS action identifier that specifies the corresponding action executed by the QoS policier circuit 30 on the data packet (e.g., “action 1”, “action 2”, or “action 3”). The QoS policier circuit 30 can add the QoS action identifier to the data packet, or alternately add an entry in the memory circuit that associates the QoS action identifier with either the data packet or an identifier for the data packet (e.g., a hash value).

Referring to operation 52, the flow identification circuit 32 can be configured to detect a new flow in response to detecting the first data packet of the new flow, and in response establish a new unique identifier that associates the QoS policier action (e.g., “action 1” (conform), “action 2” (exceed), or “action 3” (violate)) to the identification of the new flow (i.e., NFi, where i=2). As illustrated with respect to operation 52, the flow identification circuit 32 can establish the unique identifiers “NFi_conform”, “NFi_exceed”, and/or “NFi_violate” for each identified flow 24 in response to detecting the QoS action identifiers identifying that data packets of an identified flow 24 are classified into the QoS policier actions “conform”, “exceed”, and “violate”, respectively.

For example, the flow identification circuit 32 in operation can establish a first netflow monitor “MON1” that captures conform flows, a second netflow monitor “MON2” that captures exceeded flows, and a third netflow monitor “MON3” that captures violating flows. The flow identification circuit 32 can identify a new flow (e.g., “NF1”) in response to detecting a first Internet Protocol (IP) data packet “P1_{—}1” of a data flow “P1” having a source IP address of “1.1.1.1”, a destination IP address of “2.2.2.2”, a protocol type of “TCP”, a source port of “10”, and a destination port of “20”. In response to detecting the first data packet “P1_{—}1” is assigned a QoS policier action of “conform” by the QoS policier circuit 30, the flow identification circuit 22 can create the unique identifier “NF1_conform” for the first data packet “P1_{—}1”. Hence, the unique identifier “NF1_conform” associates the QoS policier action (“conform”) with the identification of the flow “P1” (identified as “NF1”). In response to detecting additional data packets from the flow “P1” (based on the same source IP address, destination IP address, protocol type, and source/destination ports), having the same QoS policier action of “conform” assigned by the QoS policier circuit 30, the flow identification circuit 32 can update a data structure storing statistics for the unique identifier “NF1_conform”, accordingly.

In response to the flow identification circuit detecting the data packet “P1_x” from the flow “P1” being assigned the QoS policier action of “exceed”, the flow identification circuit 32 creates the unique identifier “NF1_exceed” for the first data packet “P1_x” of the data flow “P1” that receives the “exceed” QoS policier action. Similarly, the flow identification circuit 32 creates the unique identifier “NF1_violate” for the first data packet “P1_y” of the data flow “P1” that receives the “violate” QoS policier action. The flow identification circuit 32 updates the statistics stored in the data structures for the unique identifiers “NF1_conform”, “NF1_exceed”, or “NF1_violate” based on the respective QoS policier actions applied to subsequent data packets in the data flow “P1”.

Hence, in operation 54 the QoS policier circuit 30 can determine the QoS policier action (e.g., “conform”, “exceed”, or “violate”) to be taken for data packets that belong to a first flow 24 of data packets received at an ingress interface 12, based on the bandwidth utilized by the data packets relative to the prescribed QoS threshold values for CAR and PIR for the single aggregated flow. In one example embodiment, the QoS classification for the data packets can be based on an instantaneous packet arrival rate, where the QoS policier circuit 30 increments a counter each millisecond, and the QoS policier circuit 30 also counts each byte received to determine whether the conform limit is reached within a prescribed time interval (e.g., 1 second): if the byte count does not exceed the conform limit (CAR) within the prescribed time interval, the next data packets are marked “conform” (action 1); if the byte count exceeds the conform limit (CAR), the next data packets can be identified as “exceeded” under “action 2” and an associated credit counter can be decremented; if the credit counter reaches zero, any further data packets are marked as “violated” under “action 3”.

The flow identification circuit 32 in operation 56 can detect the QoS policier action applied to the data packets based on the respective QoS action identifiers, and in response create a unique identifier to the new detected flow relative to the corresponding QoS policier action executed by the QoS policier circuit 30. For example, assuming data packets belonging to the first flow of data packets having the flow identifier “NF2” caused the QoS policier circuit 30 in operation 54 to execute the QoS policier action “action 2” due to the corresponding “exceed” QoS classification, the flow identification circuit 32 can detect the QoS action identifiers and in response assign the unique identifier “NF2_exceed” indicating that the first flow of data packets having the flow identifier “NF2” caused execution of the “exceed” policier action. The flow identification circuit 32 can record in operation 58 the unique identifier in a data structure stored in the memory circuit 18, for example as a tuple specifying the unique identifier, an event date and time specifying the start of the identified data flow, and a number of data packets and/or a number of data bytes of the identified flow that caused the corresponding QoS action. The unique identifiers can be aggregated by the flow identification circuit 32 into a data structure stored in the memory circuit 18 for each QoS policier action executed by the QoS policier circuit 14 for each data flow that is aggregated into the single aggregated flow 26. As apparent from the foregoing, each of these operations can be repeated for each aggregated flow 26 created by the QoS policier circuit 14, until a timeout condition is reached (e.g., the flows cease after a prescribed time interval). As described previously, the data structure for each unique identifier is created in response to the first data packet of the data flow being associated with the corresponding QoS action: subsequent data packets of the same data flow that have the same QoS action as previously applied are used to update the statistics of the corresponding data structure associated with the unique identifier.

In response to termination of the ingress data flows 24 and/or the aggregated flow 26, the flow identification circuit 32 in operation 60 can send the data structure containing the record of unique identifiers for the QoS based identification of data flows to the collector circuit 22 for archival and analysis. The collector circuit 22 in operation 62 can identify the relative proportion of each of the identified flows within each QoS classification.

Hence, the flow identifier circuit 32 can collect statistics describing the data flows that were classified as conformed, exceeded and/or violated over time. Example statistics can include the percentage of total drops (classified as violated) that a particular flow constitutes in terms of total rate; the percentage of total rate consumed by a particular flow in the conformed range; what percentage of a flow was dropped, etc. Hence, over time the statistics provided by the flow identifier circuit 32 to the collector circuit 22 enables identification of the behavioral patterns of data flows (e.g., whether a given data flow is continuous versus bursty, or whether a given data flow tends to “take over” the allocated bandwidth).

FIG. 3 illustrate example data structures 70a and 70b, generated in operation 62 by the collector circuit 22, the flow identification circuit 32 and/or an administrator circuit 20 within the apparatus 10. The quality of service based identification of data flows accumulated by the flow identification circuit 32 enables collector circuit 22, the administrator circuit 20, and/or the flow identification circuit 32 to identify the corresponding relative proportion for each of the data flows (e.g., NF1 and NF2) 24 within the conformed QoS classification 72, the exceeded QoS classification 74, and the violated QoS classification 76.

The data structure 70a illustrates a “first case” aggregation of data flows NF1 and NF2, where the data flow NF1 (9 Mbps) is determined to have three times the data traffic of the data flow NF2 (3 Mbps) (3:1). In this example, the flow identifier circuit 32 can establish that the data flow “NF1” 24 consumes seventy five percent (75%) of the conformed bandwidth (e.g., 7.5 Mbps of 10 Mbps), and the data flow “NF2” consumes twenty five percent (25%) of the conformed bandwidth (e.g., 2.5 Mbps of 10 Mbps). The flow identifier circuit 32 also can establish that the data flow “NF1” 24 causes seventy five percent (75%) of the exceed actions (e.g., 0.75 Mbps of 1.0 Mbps exceed bandwidth), and the data flow “NF2” causes twenty five percent (25%) of the exceed actions (e.g., 0.25 Mbps of 1.0 Mbps). The flow identifier circuit 32 also can establish that the data flow “NF1” 24 causes seventy five percent (75%) of the violate actions, and the data flow “NF2” causes twenty five percent (25%) of the violate actions.

Hence, the data structure 70a illustrates that the incidence of conform actions, exceed actions, and violate actions are fairly distributed (i.e., evenly distributed) between the data flows NF1 and NF2 relative to the 3″1 ratio of the respective bandwidths, where eighty three percent (83.33%) of each flow is conformed, eight percent (8.33%) of each flow is exceeded, and eight percent (8.33%) of each flow is violated. Hence, the data structure 70a illustrate that the data flows NF1 and NF2 share the single aggregated flow in equal proportions (e.g., due to a steady state streaming of both data flows NF1 and NF2)

In contrast, the data structure 70b illustrates a second case, where the data flow NF1 begins transmitting at a data rate of 9 Mbps for a time period before the initiation of the data flow NF2, causing one hundred percent (100%) of the 9 Mbps data flow NF1 to utilize ninety percent (90%) of the conformed action. Since the 3 Mbps data flow NF2 does not begin transmitting until after the 9 Mbps data flow NF1, the 3 Mbps data flow NF2 causes ten percent (10%) of the conform action at 1 Mbps, one hundred percent of the exceed action at 1 Mbps, and one hundred percent (100%) of the violate action. Consequently, one hundred percent (100%) of the 9 Mbps data flow NF1 is classified as conformed, whereas only thirty-three percent (33%) of the 3 Mbps data flow NF2 is classified as conformed. Hence, a network administrator or an autonomous system can use heuristic-based corrective action to provide better allocation to the data flow NF2 that was denied service due to the data flow NFL

Hence, a network administrator and/or heuristic logic in the apparatus 10 can detect that the identified data flow “NF2” was unfairly denied aggregation bandwidth according to the QoS policies, enabling corrective measures to be taken against the source 26 of the identified data flow NF1 24 to prevent congestion by the data flow NF2.

According to example embodiments, the flow profiles can be attached to QoS policier actions in order to reveal the patterns of data flows with respect to compliance with QoS requirements.

Any of the disclosed circuits (including the network interface circuits 12 and 16, the circuit 14 comprising the QoS policier circuit 30 and the flow identification circuit 32, the memory circuit 18, the administrator circuit 20, the collector circuit 22, and their associated components) can be implemented in multiple forms. Example implementations of the disclosed circuits include hardware logic that is implemented in a logic array such as a programmable logic array (PLA), a field programmable gate array (FPGA), or by mask programming of integrated circuits such as an application-specific integrated circuit (ASIC). Any of these circuits also can be implemented using a software-based executable resource that is executed by a corresponding internal processor circuit such as a microprocessor circuit (e.g., the administrator circuit 20) and implemented using one or more integrated circuits, where execution of executable code stored in an internal memory circuit (e.g., within the memory circuit 18) causes the integrated circuit(s) implementing the processor circuit to store application state variables in processor memory, creating an executable application resource (e.g., an application instance) that performs the operations of the circuit as described herein. Hence, use of the term “circuit” in this specification refers to both a hardware-based circuit implemented using one or more integrated circuits and that includes logic for performing the described operations, or a software-based circuit that includes a processor circuit (implemented using one or more integrated circuits), the processor circuit including a reserved portion of processor memory for storage of application state data and application variables that are modified by execution of the executable code by a processor circuit. The memory circuit 18 can be implemented, for example, using a non-volatile memory such as a programmable read only memory (PROM) or an EPROM, and/or a volatile memory such as a DRAM, etc.

Further, any reference to “outputting a message” or “outputting a packet” (or the like) can be implemented based on creating the message/packet in the form of a data structure and storing that data structure in a tangible memory medium in the disclosed apparatus (e.g., in a transmit buffer). Any reference to “outputting a message” or “outputting a packet” (or the like) also can include electrically transmitting (e.g., via wired electric current or wireless electric field, as appropriate) the message/packet stored in the tangible memory medium to another network node via a communications medium (e.g., a wired or wireless link, as appropriate) (optical transmission also can be used, as appropriate). Similarly, any reference to “receiving a message” or “receiving a packet” (or the like) can be implemented based on the disclosed apparatus detecting the electrical (or optical) transmission of the message/packet on the communications medium, and storing the detected transmission as a data structure in a tangible memory medium in the disclosed apparatus (e.g., in a receive buffer). Also note that the memory circuit 18 can be implemented dynamically by the processor circuit (e.g., 20), for example based on memory address assignment and partitioning executed by the processor circuit (e.g., 20).

The operations described with respect to FIGS. 1-3 can be implemented as executable code stored on a computer or machine readable non-transitory tangible storage medium (e.g., floppy disk, hard disk, ROM, EEPROM, nonvolatile RAM, CD-ROM, etc.) that are completed based on execution of the code by a processor circuit implemented using one or more integrated circuits; the operations described herein also can be implemented as executable logic that is encoded in one or more non-transitory tangible media for execution (e.g., programmable logic arrays or devices, field programmable gate arrays, programmable array logic, application specific integrated circuits, etc.). Hence, the operations described with respect to FIGS. 1-3 can be implemented as executable logic encoded in one or more non-transitory tangible media (e.g., the QoS policier circuit 14 can be implemented as an application specific integrated circuit).

While the example embodiments in the present disclosure have been described in connection with what is presently considered to be the best mode for carrying out the subject matter specified in the appended claims, it is to be understood that the example embodiments are only illustrative, and are not to restrict the subject matter specified in the appended claims.

What is claimed is:

1. A method comprising:
determining a Quality of Service (QoS) policier action for data packets belonging to a first flow of data packets received at an ingress interface of a network switching device, the QoS policies based on one of multiple prescribed QoS classifications by a QoS policier that aggregates distinct flows of data packets into a single aggregated flow according to prescribed QoS thresholds; and
assigning to the first flow of data packets a unique identifier that associates the QoS policier action to identification of the first flow of data packets, enabling identification of the distinct flows of data packets within each of the prescribed QoS classifications.

2. The method of claim 1, wherein the unique identifier is based on detecting the QoS policier action applied to the data packets, and creating the corresponding unique identifier for the first flow of data packets relative to the corresponding QoS policier action, wherein a corresponding unique identifier is generated for the first flow of data packets for each QoS classification applied to the first flow of data packets.

3. The method of claim 2, wherein the assigning includes recording the unique identifier for the flow of data packets having caused the corresponding QoS policier action in response to dynamic identification of the first flow of data packets.

4. The method of claim 3, further comprising identifying a corresponding relative proportion for each of the distinct flows within each of the prescribed QoS classifications that are aggregated by the QoS policier into the single aggregated data flow.

5. The method of claim 1, wherein the determining of the QoS policier action include classifying the data packets of the first flow of data packets as one of a conforming flow, an exceed flow, or a violated flow based on the data packets of the first flow having a data rate below a prescribed committed access rate, greater than the prescribed committed access rate but less than a prescribed peak information rate, or greater than the prescribed committed access rate and the prescribed peak information rate, respectively.

6. The method of claim 5, further comprising identifying a corresponding relative proportion for each of the distinct flows within each of the prescribed QoS classifications that are aggregated by the QoS policier into the single aggregated data flow.

7. The method of claim 1, further comprising identifying a corresponding relative proportion for each of the distinct flows within each of the prescribed QoS classifications that are aggregated by the QoS policier into the single aggregated data flow.

8. An apparatus comprising:
a plurality of ingress interfaces, each ingress interface configured for receiving one or more flows of data packets; and
a circuit configured for aggregating distinct flows of data packets into a single aggregated data flow according to prescribed Quality of Service (QoS) thresholds, the circuit further configured for determining a QoS policier action for at least a first of the flows of data packets, based on one of multiple prescribed QoS classifications applied to the single aggregated data flow, and assigning to the first flow of data packets a unique identifier that associates the QoS policier action to identification of the first flow of data packets, enabling identification of the distinct flows of data packets within each of the prescribed QoS classifications.

9. The apparatus of claim 8, wherein the circuit comprises a QoS policier circuit configured for executing the QoS policier action on the data packets according to the prescribed QoS classification, and a flow identifier circuit configured for detecting the QoS policier action applied to the data packets and in response creating the corresponding unique identifier for the first flow of data packets relative to the corresponding QoS policier action, wherein a corresponding unique identifier is generated for the first flow of data packets for each QoS classification applied by the QoS policier circuit to the first flow of data packets.

10. The apparatus of claim 9, wherein the flow identifier circuit is configured for recording the unique identifier for the flow of data packets having caused the corresponding QoS policier action in response to dynamic identification of the first flow of data packets.

11. The apparatus of claim 10, wherein the flow identifier circuit is configured for generating a data structure that enables identification of a corresponding relative proportion for each of the distinct flows within each of the prescribed QoS classifications that are aggregated by the QoS policier circuit into the single aggregated data flow.

12. The apparatus of claim 8, wherein the circuit comprises a QoS policier circuit configured for determining the QoS policier action based on classifying the data packets of the first flow of data packets as one of a conforming flow, an exceed flow, or a violated flow based on the data packets of the first flow having a data rate below a prescribed committed access rate, greater than the prescribed committed access rate but less than a prescribed peak information rate, or greater than the prescribed committed access rate and the prescribed peak information rate, respectively.

13. The apparatus of claim 12, wherein the circuit further comprises a flow identification circuit configured for generating a data structure that enables identification of a corresponding relative proportion for each of the distinct flows within each of the prescribed QoS classifications.

14. The apparatus of claim 8, wherein the circuit is configured for generating a data structure that enables identification of a corresponding relative proportion for each of the distinct flows within each of the prescribed QoS classifications.

15. Logic encoded in one or more non-transitory tangible media for execution by a machine and when executed operable for:
determining a Quality of Service (QoS) policier action for data packets belonging to a first flow of data packets received at an ingress interface of a network switching device, the QoS policier action based on one of multiple prescribed QoS classifications by a QoS policier that aggregates distinct flows of data packets into a single aggregated flow according to prescribed QoS thresholds; and
assigning to the first flow of data packets a unique identifier that associates the QoS policier action to identification of the first flow of data packets, enabling identification of the distinct flows of data packets within each of the prescribed QoS classifications.

16. The logic of claim 15, wherein the unique identifier is based on detecting the QoS policier action applied to the data packets, and creating the corresponding unique identifier for the first flow of data packets relative to the corresponding QoS policier action, wherein a corresponding unique identifier is generated for the first flow of data packets for each classification applied to the first flow of data packets.

17. The logic of claim 16, wherein the assigning includes recording the unique identifier for the flow of data packets having caused the corresponding QoS policier action in response to dynamic identification of the first flow of data packets.

18. The logic of claim 17, further comprising identifying a corresponding relative proportion for each of the distinct flows within each of the prescribed QoS classifications that are aggregated by the QoS policier into the single aggregated data flow.

19. The logic of claim 15, wherein the determining of the QoS policier action include classifying the data packets of the first flow of data packets as one of a conforming flow, an exceed flow, or a violated flow based on the data packets of the first flow having a data rate below a prescribed committed access rate, greater than the prescribed committed access rate but less than a prescribed peak information rate, or greater than the prescribed committed access rate and the prescribed peak information rate, respectively.

20. The logic of claim 19, further comprising identifying a corresponding relative proportion for each of the distinct flows within each of the prescribed QoS classifications that are aggregated by the QoS policier into the single aggregated data flow.
